(19) United States
(12) Patent Application Publication
(10) Pub. No.: US 2023/0299590 A1
(43) Pub. Date: Sep. 21, 2023

(54) OPTIMIZED MULTI-MODEL ELECTRICAL HEATING METHOD AND SYSTEM THEREFOR

(71) Applicant: Indian Oil Corporation Limited, Mumbai (IN)

(72) Inventors: Vibhav DIKSHIT, Faridabad (IN); Vinay TIWARI, Faridabad (IN); Umish SRIVASTVA, Faridabad (IN); Deepak SAXENA, Faridabad (IN); Sankara Sri Venkata RAMAKUMAR, Faridabad (IN)

(21) Appl. No.: 18/187,091

(22) Filed: Mar. 21, 2023

(30) Foreign Application Priority Data
Mar. 21, 2022 (IN) 202221015528

(51) Int. Cl. H02J 3/38; H02J 3/00

(52) U.S. Cl. CPC H02J 3/381; H02J 3/004

(57) ABSTRACT

A method for deriving a predetermined unit of power from a power generator using a renewable energy source is disclosed. It comprises determination of a power generation capacity of the power generator, by a control unit, based on application parameters received by the control unit associated with generation of the predetermined unit of power, operational parameters associated with the power generator, and environmental parameters associated with a location of derivation of the power from the renewable energy source. A value of resistance is then determined by the control unit to reduce power loss during power generation, wherein a resistor unit having the determined value of resistance is electrically coupled with the power generator. The control unit then derives the predetermined unit of power across the resistor unit from the power generator.

### FIELD OF THE INVENTION

The present disclosure generally relates to the field of electrical heating, and more particularly, to an optimized multi-model electrical heating method and system employed therefor.

### BACKGROUND

Electrical heating methods and systems using electrical energy have been known since long. This electrical energy is used to power the electrical heating appliances and may be in the form of conventional or non-conventional energy sources. One of the major non-conventional energy sources used for powering such electrical heating systems is solar energy among other non-conventional energy sources.

The conventional solar heating methods and systems have great potential for heating the required media without polluting the environment and using clean energy. However, there are various limitations associated with the conventional solar heating systems. For instance, the conventional solar heating systems operate in favorable operating conditions, such as clear sky and bright day that may not be available round the year. Moreover, the operation of the conventional solar heating systems is limited to daytime.

Various prior arts have been used to utilize electrical energy for heating purpose for different applications. Different configurations used in the prior arts related to solar heating systems have been discussed below:

IN201722041401 discloses a cooking system including one or more thermal storages capable of storing thermal energy using electric power received from one or more energy source. One or more heat exchanger circuit is used for transferring the thermal energy from the one or more thermal storages and a cooking unit arranged in heat exchanging relationship with the one or more thermal storages via one or more heat exchanger circuits. The cooking unit receives the thermal energy from the one or more thermal storages for cooking.

WO2017205864 discloses devices, systems, and methods relating to providing a portable, rechargeable vessel for collecting, storing, and recovering thermal energy. In one aspect, a vessel includes a structure defining a well and an open-top portion at the top of the well. One or more thermally conductive fins are interleaved in the phase-change material, and a thermally conductive heat transfer plate is disposed at and substantially covering the open-top portion of the structure, in direct thermal contact with the one or more fins, thereby allowing the transfer plate to directly exchange thermal energy with the phase change material.

WO2018044477 discloses an apparatus including a photovoltaic panel. A first fluid container is thermally attached to a bottom of the photovoltaic panel. A temperature sensor is provided for sensing temperature of a fluid inside the first fluid container, which is part of a sub-system for a power generation system using solar energy. The sub-system further includes a heating assembly, including a second fluid container, a second temperature sensor, and an electrical heating element. The second fluid container is fluidically connected to the first fluid container. The heating element is configured to heat the pre-heated fluid in the second fluid container to its vapor state. The sub-system additionally includes a turbine generator fluidically connected to the second fluid container to generate AC power from the vapor. A system employing a plurality of subsystems and a method for using the sub-systems are also provided.

However, there are major challenges present in the prior art related to accommodating the electrical heating system or method to provide efficient way to extract power from renewable energy sources / electrical grid, thereby minimalizing conversion losses.

To overcome some of the problems and shortcoming of the prior art, there is a need for a new and improved method for efficient electrical heating for domestic and industrial applications, which also helps in minimalizing conversion losses.

### SUMMARY

This summary is provided to introduce a selection of concepts, in a simplified format, that are further described in the detailed description of the invention. This summary is neither intended to identify key or essential inventive concepts of the invention and nor is it intended for determining the scope of the invention.

The present subject matter relates to a method for deriving a predetermined unit of power from at least one power generator using a renewable energy source or power grid. The method comprises receiving, by a control unit, application parameters associated with generation of the predetermined unit of power, operational parameters associated with the at least one power generator, and environmental parameters associated with a location of derivation of the power from the renewable energy source. A power generation capacity of the at least one power generator is determined by the control unit based on the application parameters, the operational parameters, and the environmental parameters. A value of resistance is then determined by the control unit to reduce power loss during power generation, wherein a resistor unit having the determined value of resistance is electrically coupled with the at least one power generator. The control unit then derives the predetermined unit of power across the resistor unit from the at least one power generator.

A system is disclosed for deriving a predetermined unit of power from at least one power generator using a renewable energy source. The system comprises a control unit adapted to receive application parameters associated with generation of the predetermined unit of power, operational parameters associated with the at least one power generator, and environmental parameters associated with a location of derivation of the power from the renewable energy source. The control unit is adapted to determine power generation capacity of the at least one power generator based on the application parameters, the operational parameters, and the environmental parameters. Further, the control unit is adapted to determine a value of resistance to reduce power loss during power generation, wherein a resistor unit having the determined value of resistance is electrically coupled with the at least one power generator. Then, the predetermined unit of power is derived by the control unit across the resistor unit from the at least one power generator.

The method and system disclosed herein help in minimalizing conversion losses while converting electrical energy into heat. Further, by optimizing resistance of each heating element, maximum energy can be extracted from renewable energy source/ electricity from grid over the period.

To further clarify advantages and features of the present invention, a more particular description of the invention will be rendered by reference to specific embodiments thereof, which is illustrated in the appended drawings. It is appreciated that these drawings depict only typical embodiments of the invention and are therefore not to be considered limiting of its scope. The invention will be described and explained with additional specificity and detail with the accompanying drawings.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 illustrates a flowchart depicting a method for deriving a predetermined unit of power from a power generator in an electrical heating system, in accordance with an embodiment of the present disclosure;

FIG. 2 illustrates a schematic diagram of components to perform the method for deriving a predetermined unit of power from a power generator in the electrical heating system, in accordance with an embodiment of the present disclosure;

FIG. 3 illustrates optimization of resistance of heating elements in the electrical heating system, in accordance with an embodiment of the present disclosure; and

FIG. 4 illustrates arrangement of electrical heating elements with a heating object, in accordance with an embodiment of the present disclosure.

Further, skilled artisans will appreciate that elements in the drawings are illustrated for simplicity and may not have necessarily been drawn to scale. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having benefit of the description herein.

### DETAILED DESCRIPTION OF FIGURES

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates. Unless otherwise defined, all technical and scientific terms used herein have the same meaning as commonly understood by one of ordinary skilled in the art to which this invention belongs. The system, methods, and examples provided herein are illustrative only and not intended to be limiting.

For example, the term “some” as used herein may be understood as “none” or “one” or “more than one” or “all.” Therefore, the terms “none,” “one,” “more than one,” “more than one, but not all” or “all” would fall under the definition of “some.” It should be appreciated by a person skilled in the art that the terminology and structure employed herein is for describing, teaching, and illuminating some embodiments and their specific features and elements and therefore, should not be construed to limit, restrict or reduce the spirit and scope of the present disclosure in any way.

For example, any terms used herein such as, “includes,” “comprises,” “has,” “consists,” and similar grammatical variants do not specify an exact limitation or restriction, and certainly do not exclude the possible addition of one or more features or elements, unless otherwise stated. Further, such terms must not be taken to exclude the possible removal of one or more of the listed features and elements, unless otherwise stated, for example, by using the limiting language including, but not limited to, “must comprise” or “needs to include.”

Whether or not a certain feature or element was limited to being used only once, it may still be referred to as “one or more features” or “one or more elements” or “at least one feature” or “at least one element.” Furthermore, the use of the terms “one or more” or “at least one” feature or element do not preclude there being none of that feature or element, unless otherwise specified by limiting language including, but not limited to, “there needs to be one or more...” or “one or more elements is required.”

Unless otherwise defined, all terms and especially any technical and/or scientific terms, used herein may be taken to have the same meaning as commonly understood by a person ordinarily skilled in the art.

Reference is made herein to some “embodiments.” It should be understood that an embodiment is an example of a possible implementation of any features and/or elements of the present disclosure. Some embodiments have been described for the purpose of explaining one or more of the potential ways in which the specific features and/or elements of the proposed disclosure fulfil the requirements of uniqueness, utility, and non-obviousness.

Use of the phrases and/or terms including, but not limited to, “a first embodiment,” “a further embodiment,” “an alternate embodiment,” “one embodiment,” “an embodiment,” “multiple embodiments,” “some embodiments,” “other embodiments,” “further embodiment”, “furthermore embodiment”, “additional embodiment” or other variants thereof do not necessarily refer to the same embodiments. Unless otherwise specified, one or more particular features and/or elements described in connection with one or more embodiments may be found in one embodiment, or may be found in more than one embodiment, or may be found in all embodiments, or may be found in no embodiments. Although one or more features and/or elements may be described herein in the context of only a single embodiment, or in the context of more than one embodiment, or in the context of all embodiments, the features and/or elements may instead be provided separately or in any appropriate combination or not at all. Conversely, any features and/or elements described in the context of separate embodiments may alternatively be realized as existing together in the context of a single embodiment.

Any particular and all details set forth herein are used in the context of some embodiments and therefore should not necessarily be taken as limiting factors to the proposed disclosure.

Embodiments of the present invention will be described below in detail with reference to the accompanying drawings.

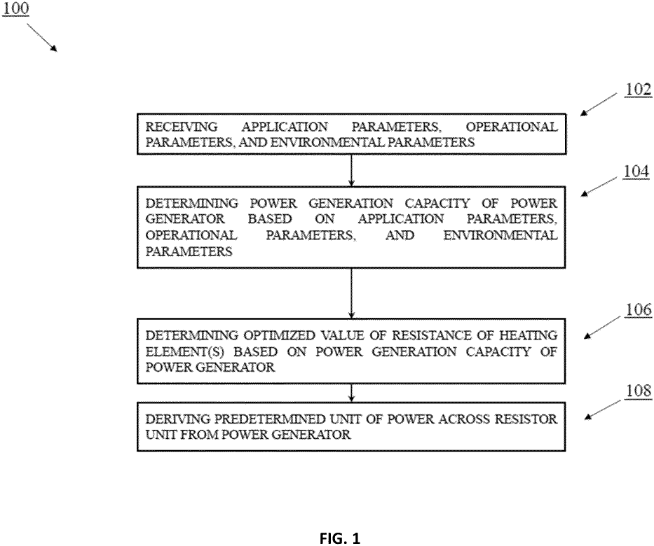

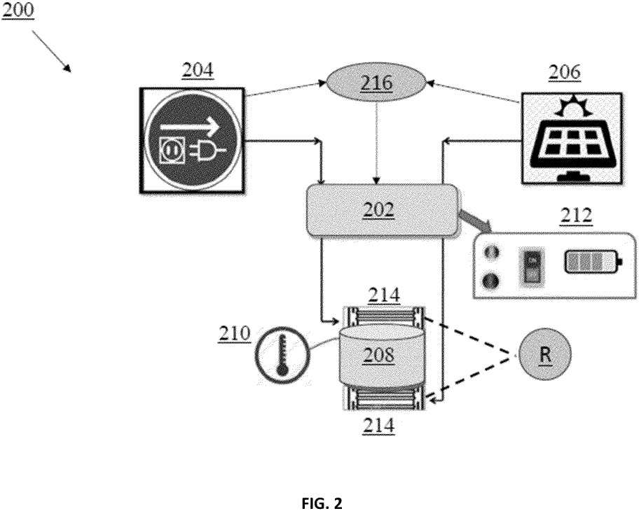

For the sake of clarity, the first digit of a reference numeral of each component of the present disclosure is indicative of the Figure number, in which the corresponding component is shown. For example, reference numerals starting with digit “1” are shown at least in FIG. 1. Similarly, reference numerals starting with digit “2” are shown at least in FIG. 2.

Embodiments of the present disclosure will be described below in detail with reference to the accompanying figures.

The present disclosure relates to an optimized method 100 of heating in an electrical heating system 200 which derives electrical energy from a renewable energy source 206 or grid electricity 204 or a combination thereof. The method 100 involves using plurality of heating elements 214 in the electrical heating system 200 and optimizing the resistances of individual heating elements 214 with respect to the input current and voltage so that the electricity is efficiently converted into heat with minimum conversion losses.

FIG. 1 illustrates a flowchart depicting steps involved in a method 100 for deriving a predetermined unit of power from a power generator in the electrical heating system 200. The is performed using the electrical heating system 200 which includes a power generator 216 coupled to a renewable energy source 206 and/or a power grid 204, heating element(s) 214, temperature sensor 210, resistor unit R, and a control unit 204 as depicted in FIG. 2. In one example, the power generator 216 may include at least one of a solar energy power generator 216, a wind energy power generator 216, a tidal energy power generator 216, a biomass energy power generator 216, and a geo-thermal energy power generator 216. The method 100 is focused towards deriving a predetermined unit of power from the power generator 216 of an electrical heating system 200.

Referring to FIG. 1, at block 102, the method 100 includes receiving, by the control unit 202, application parameters associated with generation of the predetermined unit of power, operational parameters associated with the at least one power generator 216, and environmental parameters associated with a location of derivation of the power from the renewable energy source 206. The application parameters associated with generation of the predetermined unit of power may be specific to the type of application wherein the method 100 is employed. In an example, these application parameters may include energy requirement, system parameters, and energy storage parameters among other parameters. The operational parameters associated with the at least one power generator 216 may be specific to the type of energy source the power generator 216 is connected to. In an example, the operational parameters associated with the at least one power generator 216 may include rated power, current, voltage, conversion efficiency, temperature coefficient, dimensions of the renewable energy source 206, operating temperature, system de-rating factor, and resistance among other parameters. The environmental parameters depend on the location where the renewable energy source 206 is present. In an example, such environmental parameters may include atmospheric conditions, weather conditions, temperature conditions, number of sunlight hours, pollution, seasonal conditions, and latitude and longitude of the location among other parameters. In one embodiment, the method 100 includes determining a number of power generators 216 needed to generate the predetermined unit of power.

Referring to FIG. 1, at block 104, the method 100 includes determining a power generation capacity of the power generator 216 by the control unit 202. Such determination of the power generation capacity may be based on the application parameters, the operational parameters, and the environmental parameters as explained above.

Referring again to FIG. 1, at block 106, the method 100 includes determining, by the control unit 202, an optimized value of resistance of heating element 214 to minimize the conversion power loss for maximum power extraction from the renewable energy source 206 or an electrical grid 204. A resistor unit R having the determined value of resistance is electrically coupled with the power generator 216. In one example, the resistor may be a combination of resistors of different resistance values. In another example, the resistor unit R may be a variable resistor to vary the value of resistance. Further, at block 108, the method 100 includes deriving, by the control unit the predetermined unit of power across the resistor unit R from the at least one power generator 216.

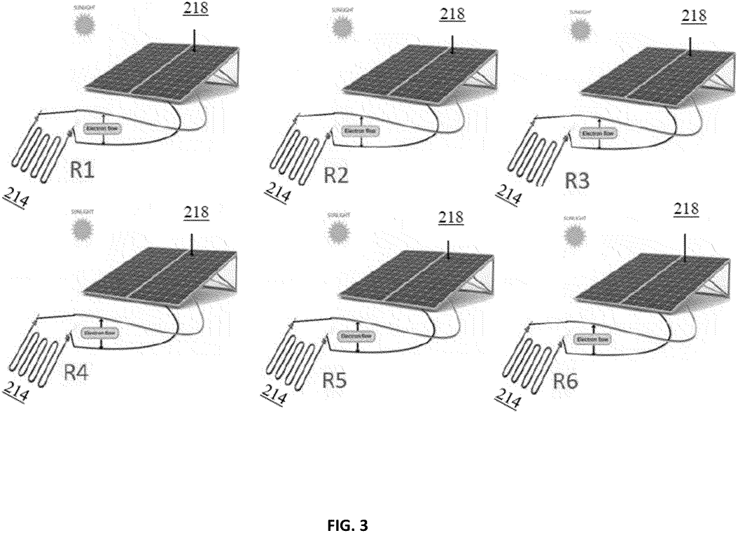

In an example, in case of solar energy as a source of electrical energy, the output characteristic of solar panel 218 depends mainly on the solar radiation. Variations in solar irradiance and cell operating temperature non- linearly affects the current voltage as well as power-voltage characteristics of a solar heating system 200. For any given set of operational conditions, solar panel 218 have a single operating point where the values of the current and voltage of the cell result in a maximum power output. These values correspond to a particular resistance of the heating element(s) 214 which may be connected to the solar panel 218. When a heating element is connected with solar panel 218, to extract maximum energy throughout the day, it is necessary that resistance of the heating element 214 should be nearby maximum power point resistance of the solar panel 218. If the resistance of the heating element 214 is lower or higher than this value, the power drawn will be less than the maximum power available, thus leading to the solar panel 218 not being used as efficiently as it could be. To meet these requirements, the method 100 disclosed herein includes selection of optimized value of electrical resistance of heating element 214 for extraction of maximum energy from solar panel 218. A range of heating elements 214 with different resistance values R1, R2, R3, R4, R5, R6 which are nearby to the rated resistance value of solar panel 218 are connected with the solar panel 218 as shown in FIG. 3.

For illustrative purposes, a set of experimental data has been generated for different resistance values corresponding to different voltage ranges of solar panel(s) 218 considering different climatic conditions (i.e., hot and cool weather). Six different load resistance values have been considered for experimental data generation. R1 to R6 load resistance values are selected as below:
R1 = (1+ 10 %) Rs,
R2 = (1+ 20 %) Rs,
R3 = (1 + 30%) Rs,
R4 = (1+40%) Rs,
R5 = (1+50%) Rs and
R6 = (1+60%) Rs,
where Rs is the rated resistance of solar panel 218.

The method 100 has been derived based on generated data which provides the optimized value of resistance of electrical heating element 214 corresponding to voltage range of solar panel 218 and particular location’s weather conditions for maximum energy extraction throughout the year. Same may be applicable for any other renewable energy sources 206/electrical grid 204 having different range of input voltage and current. In one embodiment, a non-renewable energy power source may be coupled to the system 200, as an alternative to the renewable energy power source. The control unit 202 is therefore adapted to perform round the clock optimization of resistances of individual heating elements 214 as per requirement of heating, input voltage and current. The control unit 202 is further adapted to select between the different energy sources (Renewable energy source 206 / Electrical grid 204 for identified electrical heating elements 214 for heating of object 208, and availability of energy from the renewable energy source 206. The control unit 202 is also adapted to define the cut/off and resumption of heating the object 208 until the object 208 is heated to a predetermined temperature range. The temperature of the heating object may be sensed by a temperature sensor 210, which may be coupled to the object 208. The control unit 202 may be further adapted to provide features like heating/charging status of heating object 208 from the particular energy source via a display unit 212 (shown in FIG. 2) for ease of use to the user.

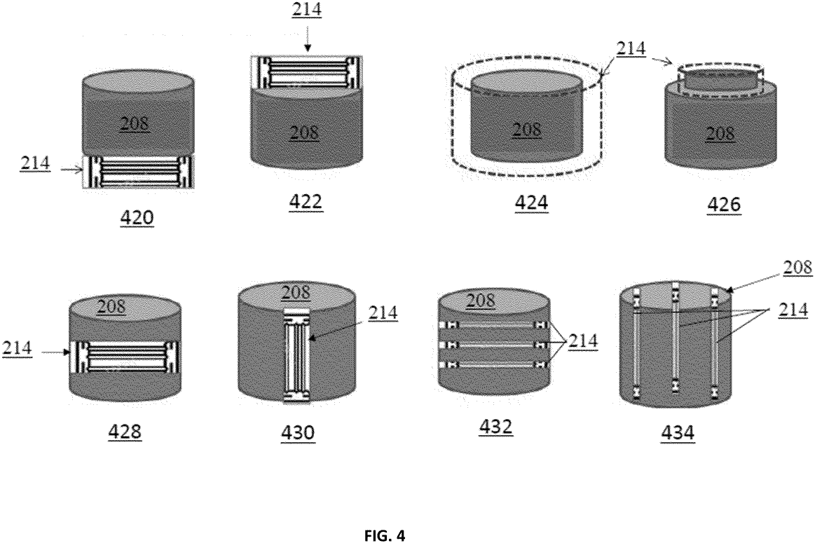

In an embodiment, the heating elements 214 therein may be arranged in a predetermined fashion for heating of an object 208, as depicted in FIG. 4. Arrangement of the heating elements 214 may be optimized as per different rate of heating requirements depending upon the input current and voltage. In an example, the object 208 to be heated may be a thermal storage material, water, food, among other examples. In an example, the heating element(s) 214 may be integrated with the object 208 in different configurations which may include but are not limited to bottom side of the object 208 and top side of the object 208 (flat heating 420, 422), around the object 208 jacket heating 424, 426, sandwiched placement 428, 430, and multiple ring heating 432, 434. Such arrangements of the heating elements 214 help in providing the required heat to the object 208 in an efficient manner, without any loss of heat energy.

The primary advantage of the method 100 and system 200 disclosed herein is that conversion losses are minimalized while converting electrical energy into heat energy. Further, by optimizing resistance of each heating element 214, maximum energy can be extracted from renewable energy source 206/ electricity from electrical grid 204 over the period. Other advantages include availability of switching between multiple energy sources 204, 206, which help in further minimalizing energy losses. Furthermore, cut off or resumption energy supply from the energy source 204, 206 further helps in avoiding over-use of energy sources.

While specific language has been used to describe the present disclosure, any limitations arising on account thereto, are not intended. As would be apparent to a person in the art, various working modifications may be made to the method in order to implement the inventive concept as taught herein. The drawings and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment.

We claim:

1. A method for deriving a predetermined unit of power from at least one power generator using a renewable energy source, the method comprising:
receiving, by a control unit, application parameters associated with generation of the predetermined unit of power, operational parameters associated with the at least one power generator, and environmental parameters associated with a location of derivation of the power from the renewable energy source;
determining, by the control unit, power generation capacity of the at least one power generator based on the application parameters, the operational parameters, and the environmental parameters;
determining, by the control unit, an optimized value of resistance of heating element to minimize the conversion power loss for maximum power extraction from the renewable energy source or an electrical grid wherein a resistor unit having the determined value of resistance is electrically coupled with the at least one power generator; and
deriving, by the control unit, the predetermined unit of power across the resistor unit from the at least one power generator.

2. The method as claimed in claim 1, comprising determining a number of power generators needed to generate the predetermined unit of power.

3. The method as claimed in claim 1, wherein the resistor unit comprising a plurality of resistors and the control unit is adapted to electrically couple at least one resistor from amongst the plurality of resistors to obtain the determined value of resistance.

4. The method as claimed in claim 1, wherein the application parameters include at least one of energy requirement, system parameters, and energy storage parameters.

5. The method as claimed in claim 1, wherein the operational parameters include at least one of rated power, current, voltage, conversion efficiency, temperature coefficient, operating temperature, system de-rating factor, and resistance.

6. The method as claimed in claim 1, wherein the environmental parameters include at least one of atmospheric conditions, weather conditions, temperature conditions, number of sunlight hours, seasonal conditions, and latitude and longitude of the location.

7. The method as claimed in claim 1, wherein the power generator includes at least one of a solar energy power generator, a wind energy power generator, a tidal energy power generator, a biomass energy power generator, and a geo-thermal energy power generator.

8. The method as claimed in claim 1, comprising coupling a non-renewable energy power source as an alternative to the renewable energy power source.

9. The method as claimed in claim 1, comprising coupling a heating system to an output of the power generator.

10. A system for deriving a predetermined unit of power from at least one power generator using a renewable energy source, the system comprising: a control unit adapted to:
receive application parameters associated with generation of the predetermined unit of power, operational parameters associated with the at least one power generator, and environmental parameters associated with a location of derivation of the power from the renewable energy source;
determine power generation capacity of the at least one power generator based on the application parameters, the operational parameters, and the environmental parameters;
determine an optimized value of resistance of heating element to minimize the conversion power loss for maximum power extraction from the renewable energy source or an electrical grid wherein a resistor unit having the determined value of resistance is electrically coupled with the at least one power generator; and
derive the predetermined unit of power across the resistor unit from the at least one power generator.
